(19) United States
(12) Patent Application Publication
(10) Pub. No.: US 2021/0189065 A1
(43) Pub. Date: Jun. 24, 2021

(54) POLYIMIDE RESIN AND PRODUCTION METHOD THEREFOR, POLYIMIDE SOLUTION, AND POLYIMIDE FILM AND PRODUCTION METHOD THEREFOR

(71) Applicant: KANEKA CORPORATION, Osaka-shi (JP)

(72) Inventor: Yasutaka KONDO, Otsu-shi (JP)

(73) Assignee: KANEKA CORPORATION, Osaka-shi (JP)

(21) Appl. No.: 16/755,195

(22) PCT Filed: Oct. 9, 2018
(86) PCT No.: PCT/JP2018/037607

§ 371 Date: Apr. 10, 2020

(30) Foreign Application Priority Data
Oct. 11, 2017 (JP) 2017-198068

(51) Int. Cl. C08G 73/10; C08J 5/18

(52) U.S. Cl. CPC C08G 73/1032; C08J 5/18

(57) ABSTRACT

A polyimide of the present invention contains an alicyclic acid dianhydride, a fluorine-containing aromatic acid dianhydride and 3′,4,4′-biphenyl-tetracarboxylic acid dianhydride as acid dianhydrides, and contains 3,3′-diaminodiphenyl sulfone and a fluoroalkyl-substituted benzidine as diamines. A polyimide film of the present invention contains the polyimide resin. For example, the polyimide film is obtained by applying a polyimide solution, which is obtained by dissolving the polyimide resin in an organic solvent, onto a substrate, and removing the solvent.

### TECHNICAL FIELD

The present invention relates to a polyimide resin and a production method for the polyimide resin, a polyimide solution, and a polyimide film and a production method for the polyimide film.

### TECHNICAL BACKGROUND

Along with rapid progresses in electronic devices such as displays, touch panels and solar cells, there are increasing demands for reduction in thickness and weight and increase in flexibility of the devices. In response to these demands, replacement of glass materials used for substrates or cover windows with plastic film materials has been studied. In particular, for applications requiring a high heat resistance, a high dimensional stability in a high-temperature and high-humidity environment, and a high mechanical strength, application of a polyimide film as an alternative material for glass has been studied.

A polyimide is excellent in heat resistance and dimensional stability. On the other hand, a general wholly aromatic polyimide is colored yellow or brown and does not exhibit solubility with respect to an organic solvent. As methods for imparting visible light transparency and solvent solubility to a polyimide, introduction of an alicyclic structure, introduction of a bent structure, introduction of a fluorine substituent, and the like are known (for example, Patent Document 1).

A polyimide film is generally produced using a method in which a polyamic acid solution which is a polyimide precursor is applied in a form of a film onto a substrate, and the solvent is removed by heating, and the polyamic acid is imidized by cyclodehydration. In production of a polyimide film, when imidization of a polyamic acid is performed together with film formation, an imidization catalyst and a dehydrating agent for the imidization, water generated by dehydration of the polyamic acid, and the like are likely to remain in the film. In thermal imidization in which an imidization catalyst or a dehydrating agent is not used, a heat treatment at a high temperature is required for imidization, and thus, a film tends to be colored yellow and transparency tends to be reduced. Further, even in thermal imidization, it is not easy to completely remove water generated by dehydration of the polyamic acid. An imidization catalyst, a dehydrating agent, water, or the like remaining in a film may cause defects such as voids, and may reduce mechanical strength or toughness of the film.

For a soluble polyimide, a film can also be produced using a method in which a polyimide resin solution is applied onto a substrate and the solvent is removed. For example, Patent Document 2 discloses an example in which a film is produced using a polyimide resin obtained from 2,2′-bis(trifluoromethyl) benzidine (TFMB) and 2,2-bis(3,4-dicarboxyphenyl) hexafluoropropane dianhydride (6FDA).

When a polyimide film is produced using a polyimide resin solution, first, an imidization catalyst and a dehydrating agent are added to a polyamic acid solution, which is obtained by a reaction between a diamine and an acid dianhydride, to perform imidization in the solution, and thereafter, the solution is mixed with a poor solvent, and thereby, a polyimide resin is precipitated and isolated. In the isolated polyimide resin, residual amounts of the imidization catalyst and the dehydrating agent or unreacted monomer components or the like are small. Further, by washing the resin after isolation, impurities can be further reduced. After a solution obtained by dissolving the isolated polyimide resin in a solvent is applied in a form of a film onto a substrate, it is only necessary to remove the solvent without the need for high-temperature heating for imidization. Therefore, a polyimide film having less coloration and an excellent transparency can be obtained.

### RELATED ART

### Patent Documents

### Patent Document 1: WO 2015/125895

### Patent Document 2: Japanese Patent Application Laid-Open Publication No. 2012-146905.

### SUMMARY OF THE INVENTION

### Problems to be Solved by the Invention

As described above, in order to obtain a polyimide film having a high transparency, a method is suitable in which imidization is performed in a solution and then film formation is performed using an isolated polyimide resin. However, the polyimide formed of a fluorine-containing aromatic diamine component and a fluorine-containing aromatic acid dianhydride component described in Patent Document 2 has insufficient mechanical strength, and its use is limited.

Patent Document 1 discloses examples of producing various transparent polyimide films. However, in all the examples, imidization is performed after a polyamic acid solution is applied onto a substrate, and no example is given in which a polyimide resin is isolated by performing imidization in a solution. The present investigator synthesized polyamic acids of compositions disclosed in Patent Document 1 and attempted chemical imidization in solutions. However, for most of the compositions, gelation or solidification occurred and a polyimide resin could not be isolated. Further, for a composition for which a polyimide resin could be isolated, the polyimide resin had insufficient mechanical strength when formed into a film.

In general, there is a trade-off relationship between solubility and mechanical strength of a polyimide. A polyimide that can be isolated without causing gelation or solidification during imidization in a solution often has insufficient mechanical strength. The present inventors have found that, by using an alicyclic acid dianhydride and a fluorine-containing aromatic acid dianhydride in combination as acid dianhydride components, and using a specific diamine component, mechanical strength of a polyimide can be improved while transparency and solubility thereof are maintained. However, a problem has been newly found that, when a ratio of the alicyclic acid dianhydride in the acid dianhydride components is increased, although mechanical strength is improved, hygroscopic expansion is increased and dimensional stability of a polyimide film is reduced.

In view of the above-described situation, the present invention is intended to provide a polyimide resin that has a high solubility in a solvent, can be imidized in a solution, has less coloration, is excellent in transparency and mechanical strength, and has a small dimensional change that occurs due to moisture absorption.

### Means for Solving the Problems

A polyimide of the present invention contains, as acid dianhydride components, an alicyclic acid dianhydride, a fluorine-containing aromatic acid dianhydride, and 3,3′,4,4′-biphenyl-tetracarboxylic acid dianhydride, and contains, as diamine components, a fluoroalkyl-substituted benzidine and 3,3′-diaminodiphenyl sulfone.

As the alicyclic acid dianhydride, 1,2,3,4-cyclobutanetetracarboxylic acid dianhydride, 1,2,3,4-cyclopentanetetracarboxylic acid dianhydride, 1,2,4,5-cyclohexanetetracarboxylic acid dianhydride, and the like are preferably used. As the fluorine-containing aromatic acid dianhydride, 2,2-bis(3,4-dicarboxyphenyl)-1,1,1,3,3,3-hexafluoropropane dianhydride is preferably used. As the fluoroalkyl-substituted benzidine, a fluoromethyl-substituted benzidine such as 2,2′-bis(trifluoromethyl) benzidine is preferably used.

In the polyimide of the present invention, with respect to a total amount of the acid dianhydrides, a total content of the alicyclic acid dianhydride and the 3,3′,4,4′-biphenyl-tetracarboxylic acid dianhydride is preferably 40-95 mol %, and a content of the fluorine-containing aromatic acid dianhydride is preferably 5-60 mol %. A content of the 3,3′,4,4′-biphenyl-tetracarboxylic acid dianhydride with respect to a total amount of the alicyclic acid dianhydride and the 3,3′,4,4′-biphenyl-tetracarboxylic acid dianhydride is preferably 10-40 mol %. A content of the 3,3′,4,4′-biphenyl-tetracarboxylic acid dianhydride with respect to the total amount of the acid dianhydrides is preferably 5-40 mol %.

In the polyimide of the present invention, with respect to a total amount of the diamines, a content of the fluoroalkyl-substituted benzidine is preferably 10-90 mol %, and a content of the 3,3′-diaminodiphenyl sulfone is preferably 10-90 mol %.

A polyamic acid is obtained by causing the diamines and the acid dianhydrides of the above compositions to react with each other, and a polyimide is obtained by subjecting the polyamic acid to cyclodehydration. For the polyimide of the present invention, in addition to that the polyimide resin itself is solvent soluble, gelation or solidification during imidization in a solution is unlikely to occur, and an imidization reaction can be performed in a solution. In one embodiment of the present invention, a polyamic acid solution is prepared by causing a diamine and an acid dianhydride to react with each other in a solvent, and, by adding a dehydrating agent and an imidization catalyst to the polyamic acid solution, imidization in the solution is performed. By mixing the solution after imidization with a poor solvent for a polyimide, it is possible to precipitate and isolate a polyimide resin.

The present invention relates to a polyimide solution obtained by dissolving the above polyimide resin in a solvent, and a film containing the above polyimide resin. The polyimide film of the present invention can be obtained by applying the polyimide solution onto a substrate and removing the solvent.

### Effect of Invention

The polyimide of the present invention has excellent solubility. Gelation or solidification is unlikely to occur during imidization in a solution obtained from a polyamic acid. Therefore, a polyimide resin having less impurities can be easily isolated. By dissolving the polyimide resin in a solvent to form a film, a polyimide film having a high transparency can be obtained. Further, the polyimide of the present invention can achieve both good transparency and good mechanical strength, and has a small dimensional change that occurs due to moisture absorption. Therefore, the polyimide film of the present invention has a small damage or dimensional change in a production process of device, and can be suitably used, for example, as a substrate material for a display.

### MODE FOR CARRYING OUT THE INVENTION

[Composition of Polyimide]

A polyimide is generally obtained by subjecting a polyamic acid to cyclodehydration, the polyamic acid being obtained by a reaction between a tetracarboxylic acid dianhydride (hereinafter, may be simply referred to as an “acid dianhydride”) and a diamine. That is, a polyimide has a structure derived from an acid dianhydride and a structure derived from a diamine.

<Acid Dianhydrides>

A polyimide of the present invention contains, as acid dianhydride components, an alicyclic acid dianhydride, a fluorine-containing aromatic acid dianhydride, and 3,3′,4,4′-biphenyl-tetracarboxylic acid dianhydride (hereinafter, referred to as “BPDA”). By containing, as acid dianhydride components, these 3 components, the polyimide has an excellent transparency and mechanical strength, and exhibits a high solubility with respect to an organic solvent, and, in addition, tends to have a small dimensional change that occurs due to moisture absorption.

The alicyclic acid dianhydride mainly contributes to an improvement in the mechanical strength of the polyimide. Examples of the alicyclic acid dianhydride include 1,2,3,4-cyclobutanetetracarboxylic acid dianhydride, 1,2,3,4-cyclopentanetetracarboxylic acid dianhydride, 1,2,4,5-cyclohexanetetracarboxylic acid dianhydride, and 1,1′-bicyclohexane-3,3′,4,4′-tetracarboxylic acid-3,4,3′,4′-dianhydride. Among them, from a point of view allowing a polyimide having excellent transparency and mechanical strength to be obtained, as the alicyclic acid dianhydride, 1,2,3,4-cyclobutanetetracarboxylic acid dianhydride, 1,2,3,4-cyclopentanetetracarboxylic acid dianhydride, or 1,2,4,5-cyclohexanetetracarboxylic acid dianhydride is preferable, and 1,2,3,4-cyclobutanetetracarboxylic acid dianhydride is particularly preferable.

The fluorine-containing aromatic acid dianhydride mainly contributes to an improvement in the solubility. Examples of the fluorine-containing aromatic acid dianhydride include 2,2-bis(3,4-dicarboxyphenyl)-1,1,1,3,3,3-hexafluoropropane dianhydride, 2,2-bis{4-[4-(1,2-dicarboxy) phenoxy]phenyl}-1,1,1,3,3,3-hexafluoropropane dianhydride, and the like. By using the fluorine-containing aromatic acid dianhydride as an acid dianhydride component in addition to the alicyclic acid dianhydride, the transparency and the solubility of the polyimide tend to be improved, and it is particularly effective for suppressing gelation during imidization in a solution.

The BPDA mainly contributes to an improvement in the mechanical strength and the dimensional stability. By using the BPDA as an acid dianhydride component in addition to the alicyclic acid dianhydride and the fluorine-containing aromatic acid dianhydride, hygroscopic expansion can be reduced while the transparency and the mechanical strength of the polyimide are maintained.

The polyimide of the present invention may also contain, as an acid dianhydride component, a component other than the alicyclic acid dianhydride, the fluorine-containing aromatic acid dianhydride and the BPDA. Examples of acid dianhydrides include aromatic tetracarboxylic acid dianhydrides having four carbonyls bonded to one aromatic ring, such as pyromellitic acid dianhydride, 1,2,5,6-naphthalenetetracarboxylic acid dianhydride, and 2,3,6,7-naphthalenetetracarboxylic acid dianhydride; and aromatic tetracarboxylic acid dianhydrides having two carbonyl groups bonded to each of different aromatic rings, such as 2,2-bis[4-(3,4-dicarboxyphenoxy) phenyl]propane dianhydride, 2,2-bis[4-(3,4-dicarboxyphenoxy) phenyl] hexafluoropropane dianhydride, 2,2-bis(4-hydroxyphenyl) propane dibenzoate-3,3′,4,4′-tetracarboxylic acid dianhydride, 3,3′,4,4′-biphenyl-tetracarboxylic acid dianhydride, 2,3,3′,4′-biphenyl-tetracarboxylic acid dianhydride, 4,4′-(hexafluoroisopropylidene) diphthalic acid anhydride, 3,3′,4,4′-benzophenonetetracarboxylic acid dianhydride, 3,4′-oxydiphthalic acid anhydride, 4,4′-oxydiphthalic acid anhydride, and 3,3′,4,4′-diphenylsulfonetetracarboxylic acid dianhydride.

As described above, when the BPDA is used as an acid dianhydride component, the hygroscopic expansion can be reduced while the transparency and the mechanical strength of the polyimide are maintained. On the other hand, when an aromatic acid dianhydride other than the BPDA is used, although the hygroscopic expansion tends to be reduced, the mechanical strength, the transparency, the solubility, and the like tend to decrease. Therefore, in a total amount of 100 mol % of the acid dianhydride components, a total amount of the alicyclic acid dianhydride, the fluorine-containing aromatic acid dianhydride and the BPDA is preferably 80 mol % or more, more preferably 85 mol % or more, even more preferably 90 mol % or more, and particularly preferably 95 mol % or more. Among them, a total amount of the 1,2,3,4-cyclobutanetetracarboxylic acid dianhydride, the 2,2-bis(3,4-dicarboxyphenyl)-1,1,1,3,3,3-hexafluoropropane dianhydride and the BPDA is preferably within the above range.

<Diamine>

The polyimide of the present invention contains, as diamine components, a fluoroalkyl-substituted benzidine (which is a fluorine-containing aromatic diamine) and 3,3′-diaminodiphenyl sulfone (hereinafter, referred to as “3,3′-DDS”) (which is a sulfonyl group-containing diamine).

In general, by using, as a diamine component, a fluorine-containing aromatic diamine or a diamine having a bent structure, the solubility of the polyimide tends to be improved. Among them, the 3,3′-DDS contributes greatly to an improvement in the solubility. In the present invention, by using the fluoroalkyl-substituted benzidine (which is a fluorine-containing aromatic diamine) and the 3,3′-DDS (which is a diamine having a bent structure) in combination as diamine components, a polyimide having a high mechanical strength and excellent transparency and solubility can be obtained.

The fluoroalkyl-substituted benzidine has a fluoroalkyl group on one or both benzene rings of 4,4′-diaminobiphenyl. The fluoroalkyl-substituted benzidine may have multiple fluoroalkyl groups on one benzene ring. As a fluoroalkyl group, a trifluoromethyl group is preferable. Specific examples of trifluoromethyl-substituted benzidines include trifluoromethyl-substituted benzidines having one or more trifluoromethyl groups on one of benzene rings, such as 2-(trifluoromethyl) benzidine, 3-(trifluoromethyl) benzidine, 2,3-bis(trifluoromethyl) benzidine, 2,5-bis(trifluoromethyl) benzidine, 2,6-bis(trifluoromethyl) benzidine, 2,3,5-tris(trifluoromethyl) benzidine, 2,3,6-tris(trifluoromethyl) benzidine, and 2,3,5,6-tetrakis(trifluoromethyl) benzidine; and trifluoromethyl-substituted benzidines having one or more trifluoromethyl groups on each of two benzene rings, such as 2,2′-bis(trifluoromethyl) benzidine, 3,3′-bis(trifluoromethyl) benzidine, 2,3′-bis(trifluoromethyl) benzidine, 2,2′,3-tris(trifluoromethyl) benzidine, 2,3,3′-tris(trifluoromethyl) benzidine, 2,2′,5-tris(trifluoromethyl) benzidine, 2,2′,6-tris(trifluoromethyl) benzidine, 2,3′,5-tris(trifluoromethyl) benzidine, 2,3′,6,-tris(trifluoromethyl) benzidine, 2,2′,3,3′-tetrakis(trifluoromethyl) benzidine, 2,2′,5,5′-tetrakis(trifluoromethyl) benzidine, and 2,2′,6,6′-tetrakis(trifluoromethyl) benzidine.

Among them, a trifluoromethyl-substituted benzidine having one or more trifluoromethyl groups on each of two benzene rings is preferable, and 2,2′-bis(trifluoromethyl) benzidine, or 3,3′-bis(trifluoromethyl) benzidine is particularly preferable. From a point of view of the solubility, the transparency and the like of the polyimide, the 2,2′-bis(trifluoromethyl) benzidine is particularly preferable.

The polyimide of the present invention may have, as a structure derived from a diamine, a structure derived from a diamine other than those described above. Examples of diamines other than those described above include: fluorine-containing aromatic diamines other than fluoroalkyl-substituted benzidines; sulfonyl group-containing diamines other than the 3,3′-DDS; diamines having two amino groups bonded to one aromatic ring, such as p-phenylenediamine, m-phenylenediamine, and o-phenylenediamine; aromatic diamines having an amino group bonded to each of different aromatic rings, such as diaminodiphenyl ether, diaminodiphenyl sulfide, diaminobenzophenone, diaminodiphenylalkane, and bis(aminobenzoyl) benzene; and alicyclic diamines such as diaminocyclohexane, and isophoronediamine.

From a point of view of the transparency, the solubility and the mechanical strength of the polyimide, in a total amount of 100 mol % of the diamine components, a total amount of the fluoroalkyl-substituted benzidine and the 3,3′-DDS is preferably 70 mol % or more, more preferably 80 mol % or more, even more preferably 85 mol % or more, and particularly preferably 90 mol % or more. Among them, a total amount of the 2,2′-bis(trifluoromethyl) benzidine and the 3,3′-DDS is preferably within the above range.

<Compositions of Diamines and Acid Dianhydrides>

As described above, the polyimide of the present invention contains the alicyclic acid dianhydride, the fluorine-containing aromatic acid dianhydride and the BPDA as the acid dianhydride components, and contains the 3,3′-DDS and the fluoroalkyl-substituted benzidine as the diamine components.

From a point of view of obtaining a polyimide having a high mechanical strength, a total content of the alicyclic acid dianhydride and the BPDA with respect to a total amount of the acid dianhydrides is preferably 40-95 mol %, more preferably 45-85 mol %, and even more preferably 50-80 mol %. From a point of view of increasing the solubility of the polyimide resin and preventing gelation during imidization in a solution, a content of the fluorine-containing aromatic acid dianhydride with respect to the total amount of the acid dianhydrides is preferably 5-60 mol %, more preferably 15-55 mol %, and even more preferably 20-50 mol %.

From a point of view of suppressing the hygroscopic expansion of the polyimide and improving the dimensional stability, a content of the BPDA with respect to a total amount of the alicyclic acid dianhydride and the BPDA is preferably 10 mol % or more, more preferably 15 mol % or more, more preferably 20 mol % or more, and even more preferably 25 mol % or more. On the other hand, when a ratio of the BPDA increases and a ratio of the alicyclic acid dianhydride decreases, the solubility of the polyimide resin in a solvent tends to decrease. Therefore, the content of the BPDA with respect to the total amount of the alicyclic acid dianhydride and the BPDA is preferably 70 mol % or less, more preferably 60 mol % or less, and even more preferably 50 mol % or less. In particular, from a point of view of obtaining a polyimide resin that exhibits solubility with respect to a low boiling point solvent such as a ketone-based solvent, the content of the BPDA with respect to the total amount of the alicyclic acid dianhydride and the BPDA is preferably 40 mol % or less, and more preferably 35 mol % or less.

From a point of view of suppressing the hygroscopic expansion of the polyimide and improving the dimensional stability, a content of the BPDA with respect to the total amount of the acid dianhydrides is preferably 5 mol % or more, more preferably 10 mol % or more, and even more preferably 15 mol % or more. From a point of view of obtaining a polyimide resin having an excellent solubility in a solvent and having an excellent transparency, the content of the BPDA with respect to the total amount of the acid dianhydrides is preferably 40 mol % or less, more preferably 30 mol % or less, and even more preferably 25 mol % or less.

Since the BPDA is an aromatic acid dianhydride, as the content of the BPDA in the acid dianhydride components increases, light transmittance in a near ultraviolet region of wavelengths of 350 nm or more and in a visible region of wavelengths near 400 nm tends to decrease. When the content of the BPDA is within the above range, influence of coloration due to a decrease in visible light transmittance is small. On the other hand, as the content of the BPDA increases, light transmittance in a near ultraviolet region of wavelengths of 350 nm or more, especially around 380 nm, significantly decreases. Therefore, by containing the BPDA as an acid dianhydride component, it is possible to impart ultraviolet absorptivity while maintaining the visible light transparency. Therefore, the polyimide film of the present invention is also suitable for applications requiring ultraviolet absorptivity. In a case where an ultraviolet absorbing agent is added for a purpose of imparting ultraviolet absorptivity, an additive amount of the ultraviolet absorbing agent can be reduced, and thus, problems such as a decrease in transparency (increase in haze) due to bleed out of the ultraviolet absorbing agent can be prevented.

From a point of view of allowing the polyimide to achieve both good solubility and good transparency, a content of the fluoroalkyl-substituted benzidine with respect to a total amount of the diamine components is preferably 10-90 mol %, more preferably 30-85 mol %, even more preferably 40-80 mol %, and particularly preferably 50-75 mol %. From the same point of view, a content of the 3,3′-DDS with respect to the total amount of the diamine components is preferably 10-90 mol %, more preferably 15-70 mol %, even more preferably 20-60 mol %, and particularly preferably 25-50 mol %.

From a point of view of allowing the polyimide to achieve both good solubility and good mechanical strength, ratios of the 3,3′-DDS and the fluoroalkyl-substituted benzidine in the diamine components and ratios of the alicyclic acid dianhydride, the BPDA and the fluorine-containing aromatic acid dianhydride in the acid dianhydride components are preferably within predetermined ranges. In particular, a content (x) of the 3,3′-DDS with respect to a total amount of 100 mol % of the 3,3′-DDS and the fluoroalkyl-substituted benzidine and a total content (y) of the alicyclic acid dianhydride and the BPDA with respect to a total amount of 100 mol % of the alicyclic acid dianhydride, the fluorine-containing aromatic acid dianhydride and the BPDA preferably satisfy the following relationships (1) and (2).

y≤0.4x+70 (1)

y≤1.8x+20 (2)

A polyimide for which x and y are in the above ranges tends to have excellent solubility in a solvent. The solubility of the polyimide refers to solubility during imidization in a solution obtained by cyclodehydration of a polyamic acid, and refers to solubility of the polyimide itself in a solvent. “Having solubility during imidization” means that solid substances and turbidity do not occur when imidization is performed by adding a dehydrating agent and an imidization catalyst or the like to a polyamide acid solution. The “solubility of the polyimide itself” means that solid substances and turbidity do not occur when the polyimide resin is dissolved in a solvent used in preparation of a solution (dope) for film formation. A soluble polyimide has the above characteristics when solid content concentrations of a polyamic acid solution and a polyimide solution are preferably 10 weight % or more, more preferably 15 weight % or more, and even more preferably 20 weight % or more.

When only the fluorine-containing aromatic acid dianhydride is contained as an acid dianhydride (y=0), the polyimide exhibits a high solubility even when only the fluoroalkyl-substituted benzidine is used as a diamine (x=0) (for example, the above-described Patent Document 2). However, a polyimide containing only the fluorine-containing aromatic acid dianhydride as an acid dianhydride component has insufficient mechanical strength. As described above, the polyimide of the present invention contains the alicyclic acid dianhydride and the BPDA as acid dianhydride components in addition to the fluorine-containing aromatic acid dianhydride, and thus, has excellent mechanical strength and small hygroscopic expansion. In particular, when y is 40 or more, the effect of improving the mechanical strength tends to be remarkable.

On the other hand, when a ratio of the alicyclic acid dianhydride and the BPDA is increased, when imidization is performed by adding a dehydrating agent and an imidization catalyst to a polyamic acid solution, viscosity of the solution rapidly increases and gelation or solidification occurs, and it may become difficult to obtain a polyimide resin. Therefore, a total amount of the alicyclic acid dianhydride and the BPDA with respect to a total amount of the alicyclic acid dianhydride, the BPDA and the fluorine-containing aromatic acid dianhydride is preferably 95 mol % or less. In other words, the content of the fluorine-containing aromatic acid dianhydride with respect to the total amount of the alicyclic acid dianhydride, the BPDA and the fluorine-containing aromatic acid dianhydride is 5 mol % or more.

When the alicyclic acid dianhydride and the BPDA are used as acid dianhydrides in addition to the fluorine-containing aromatic acid dianhydride, as compared to a case where only the fluorine-containing aromatic acid dianhydride is used as an acid dianhydride, the polyimide has low solubility, and, when only the fluoroalkyl-substituted benzidine is used as a diamine, gelation or solidification occurs during imidization of a polyamic acid solution. By using the 3,3′-DDS as a diamine in addition to the fluoroalkyl-substituted benzidine, gelation or solidification can be suppressed. A content of the 3,3′-DDS with respect to a total amount of the 3,3′-DDS and the fluoroalkyl-substituted benzidine is preferably 10 mol % or more.

As the ratio of the 3,3′-DDS increases, the solubility of the polyimide tends to increase. On the other hand, the mechanical strength tends to decrease. Further, when the ratio of the 3,3′-DDS is large, it is possible that the polyimide is colored yellow and the transparency is reduced. From a point of view of maintaining the effect of improving the mechanical strength by using the alicyclic acid dianhydride and the BPDA and obtaining a polyimide having an excellent transparency, the content of the 3,3′-DDS with respect to the total amount of the 3,3′-DDS and the fluoroalkyl-substituted benzidine is 90 mol % or less. In other words, the content of the fluoroalkyl-substituted benzidine with respect to the total amount of the 3,3′-DDS and the fluoroalkyl-substituted benzidine is 10 mol % or more.

As described above, in order to increase the mechanical strength of the polyimide and to prevent gelation or solidification during imidization from a polyamic acid solution, the range of x is preferably 10-90, and the range of y is preferably 15-95. x is preferably 15-70, more preferably 20-60, and even more preferably 25-50. y is preferably 30-90, more preferably 45-85, and even more preferably 50-80.

From a point of view of increasing the mechanical strength of the polyimide, it is preferable to increase the ratio of the alicyclic acid dianhydride and the BPDA and the ratio of the fluoroalkyl-substituted benzidine. That is, when y is increased and x is decreased, the mechanical strength of the polyimide tends to be improved. In order to obtain a polyimide having a high mechanical strength (for example, a film produced from the polyimide resin has a pencil hardness of 2H or more), x and y preferably satisfy y≥x−50.

For a larger value of (y−x), the mechanical strength of the polyimide tends to be higher. The value of (y−x) is preferably −25 or more, more preferably −20 or more, even more preferably −15 or more, and particularly preferably −10 or more. In particular, in order to obtain a polyimide film having a pencil hardness of 4H or more, (y−x) is preferably 0 or more (that is, y≥x), more preferably 5 or more, even more preferably 10 or more, even more preferably 15 or more, and particularly preferably 20 or more.

From a point of view of increasing the mechanical strength of the polyimide, (y−x) is preferably large. On the other hand, when y is large (the ratio of the alicyclic acid dianhydride component and the BPDA is large) and x is small (the ratio of the 3,3′-DDS is small), the solubility of the polyimide is low and, in particular, gelation or solidification during imidization of a polyamic acid solution is likely to occur.

When the ratio of the 3,3′-DDS is large and x is larger than 60, when y≤95 is satisfied, gelation during imidization from a polyamic acid does not occur and a soluble polyimide can be obtained. On the other hand, when the ratio (x) of the 3,3′-DDS is set to 60 or less in order to increase the mechanical strength and the transparency of the polyimide, the solubility of the polyimide tends to rapidly decrease, and, in order to prevent gelation during imidization, it is necessary to reduce y as x (the ratio of the 3,3′-DDS) is decreased. The formula (1) shows a range in which a polyimide can be obtained without occurrence of gelation when x is about 60 or less. When x is further reduced, the solubility of the polyimide becomes more sensitive to a change in the ratio (y) of the alicyclic acid dianhydride. The formula (2) shows a range in which a polyimide can be obtained without occurrence of gelation when x is about 35 or less.

That is, the formula (2) shows the range in which gelation during imidization can be prevented when x is in the range of about 10-35, and the formula (1) shows the range in which gelation during imidization can be prevented when x is in the range of about 35-60. When x is 60 or more, y may be 95 or less.

As described above, when the ratio (y) of the total amount of the alicyclic acid dianhydride and the BPDA is larger, the mechanical strength of the polyimide tends to be higher. Therefore, from a point of view of obtaining a polyimide having a high mechanical strength, a larger y is preferable as long as y is in a range in which the formulas (1) and (2) are satisfied, and points formed by plotting x and y are preferably in vicinities of straight lines represented by these formulas. On the other hand, in the vicinities of the formulas (1) and (2), although gelation or solidification can be prevented, the viscosity of the solution may rapidly increase during imidization. Therefore, in order to obtain a polyimide having a higher solubility, as described above, y is preferably 90 or less, more preferably 85 or less, and even more preferably 80 or less. From the same point of view, x and y preferably satisfy y≤0.4x+65. Further, x and y preferably satisfy y≤1.8x+15.

As described above, the polyimide of the present invention exhibits a high mechanical strength by containing the alicyclic acid dianhydride and the BPDA as acid dianhydride components in addition to the fluorine-containing aromatic acid dianhydride, and can ensure solubility by containing the 3,3′-DDS as a diamine component in addition to the fluoroalkyl-substituted benzidine. By setting the ratios (x, y) of the acid dianhydrides and the diamine within predetermined ranges, the mechanical strength of the polyimide can be further increased while maintaining the solubility and preventing gelation or solidification during imidization. Further, by setting the ratio of the alicyclic acid dianhydride and the BPDA within a predetermined range, a polyimide resin having a low hygroscopic expansion and a high solubility even with respect to a low boiling point solvent such as a ketone-based solvent can be obtained.

[Preparation of Polyimide Resin]

<Polyamic Acid>

As described above, the polyimide is obtained by cyclodehydration of a polyimide acid which is a polyimide precursor. A polyamic acid can be obtained, for example, by causing an acid dianhydride and a diamine to react with each other in an organic solvent. The acid dianhydride and the diamine are preferably used at substantially equimolar amounts (a molar ratio in a range of 95:100-105:100). In order to suppress ring opening of the acid dianhydride, a method is preferable in which the diamine is dissolved in a solvent and then the acid dianhydride is added. When multiple kinds of diamines or multiple kinds of acid dianhydrides are added, the addition may be performed at once or may be added in multiple times. A polyamic acid solution is usually obtained at a concentration of 5-35 weight %, preferably 10-30 weight %.

In polymerization of a polyamic acid, an organic solvent that cab dissolve a diamine and an acid dianhydride as raw materials and can dissolve the polyamic acid as a polymerization product can be used without particular limitation. Specific examples of the organic solvent include: urea-based solvents such as methyl urea, and N,N-dimethylethyl urea; sulfone-based solvents such as dimethyl sulfoxide, diphenyl sulfone, and tetramethyl sulfone; amide-based solvents such as N,N-dimethylacetamide, N,N-dimethylformamide, N,N′-diethylacetamide, N-methyl-2-pyrrolidone, γ-butyrolactone, and hexamethylphosphoric triamide; alkyl halide-based solvents such as chloroform and methylene chloride; aromatic hydrocarbon-based solvents such as benzene and toluene; and ether-based solvents such as tetrahydrofuran, 1,3-dioxolan, 1,4-dioxane, dimethyl ether, diethyl ether and p-cresol methyl ether. Among them, from a point of view of being excellent in polymerization reactivity and polyamic acid solubility, dimethylacetamide, dimethylformamide, or N-methylpyrrolidone is preferably used.

<Imidization>

A polyimide is obtained by cyclodehydration of a polyamic acid. For imidization in a solution, a chemical imidization method is suitable in which a dehydrating agent and an imidization catalyst are added to a polyamic acid solution. In order to promote progress of the imidization, the polyamic acid solution may be heated.

Tertiary amines are used as imidization catalysts. Among them, heterocyclic tertiary amines such as pyridine, picoline, quinoline and isoquinoline are preferable. Acid anhydrides such as acetic anhydride, propionic acid anhydride, butyric acid anhydride, benzoic acid anhydride and trifluoroacetic acid anhydride are used as dehydrating agents. An additive amount of an imidization catalyst with respect to an amide group of a polyamic acid is preferably 0.5-5.0 molar equivalents, more preferably 0.6-2.5 molar equivalents, and even more preferably 0.7-2.0 molar equivalents. An additive amount of a dehydrating agent with respect to an amide group of a polyamic acid is preferably 0.5-10.0 molar equivalents, more preferably 0.7-7.0 molar equivalents, and even more preferably 1.0-5.0 molar equivalents.

In imidization of a polyamic acid by cyclodehydration, a nitrogen atom of amide is nucleophilic to a carbonyl carbon of a carboxylic acid, and thereby, one molecule of water is eliminated with formation of one C—N bond. An intermediate of this reaction has a lower solubility than a polyimide which is a reaction product. Therefore, even when a polyamic acid and a polyimide exhibit solubility with respect to a solvent, when an accumulated amount of a reaction intermediate during imidization increases, an increase in viscosity or gelation may occur. Therefore, even when a polyimide exhibits solubility with respect to a solvent, imidization in a solution may be difficult depending on a composition. As described above, by using predetermined acid dianhydrides and diamines at ratios in predetermined ranges, in addition to that the polyimide itself exhibits a high solubility with respect to a solvent, gelation due to a rapid increase in viscosity during imidization can be prevented.

<Precipitation of Polyimide Resin>

Although a polyimide solution obtained by imidization of a polyamic acid can be used as it is as a film-forming dope, it is preferable that a polyimide resin is once precipitated as a solid. By precipitating a polyimide resin as a solid, impurities generated during polymerization of the polyamic acid, and remaining monomer components, dehydrating agent and imidization catalyst and the like can be removed by washing. Therefore, a polyimide film having excellent transparency and mechanical characteristics can be obtained.

By mixing the polyimide solution with a poor solvent, a polyimide resin precipitates. The poor solvent is a poor solvent for the polyimide resin and is preferably miscible with a solvent in which the polyimide resin is dissolved, and examples thereof include water, alcohols, and the like. Examples of alcohols include methyl alcohol, ethyl alcohol, isopropyl alcohol, ethylene glycol, triethylene glycol, 2-butyl alcohol, 2-hexyl alcohol, cyclopentyl alcohol, cyclohexyl alcohol, phenol, t-butyl alcohol, and the like. From a point of view that ring-opening or the like of a polyimide is unlikely to occur, alcohols such as isopropyl alcohol, 2-butyl alcohol, 2-pentyl alcohol, phenol, cyclopentyl alcohol, cyclohexyl alcohol and t-butyl alcohol are preferable, and isopropyl alcohol is particularly preferable.

Prior to mixing the polyimide resin solution with a poor solvent, a solid content concentration of the polyimide solution may be adjusted. The solid content concentration of the polyimide solution is preferably about 3-30 weight %. Methods for mixing a polyimide resin solution with a poor solvent include a method in which a polyimide solution is put into a poor solvent solution, a method in which a poor solvent is put into a polyimide solution, a method in which a poor solvent and a polyimide solution are simultaneously mixed, and the like. An amount of the poor solvent is preferably equal to or more than an amount of the polyimide resin solution, more preferably 1.5 or more times (in volume) the amount of the polyimide resin solution, and even more preferably 2 or more times (in volume) the amount of the polyimide resin solution.

Since a small amount of the imidization catalyst, the dehydrating agent or the like may remain in the precipitated polyimide resin, it is preferable to perform washing with a poor solvent. The poor solvent is preferably removed by vacuum drying, hot air drying, or the like from the polyimide resin after precipitation and washing. A drying method may be vacuum drying or hot air drying. A drying condition may be appropriately set according to the type of the solvent and the like. A polyimide resin solid substance is a solid substance that can include various forms such as a powdery form and a flake form, and an average particle size thereof is preferably 5 mm or less, more preferably 3 mm or less, and particularly preferably 1 mm or less.

A weight average molecular weight of the polyimide is preferably 5,000-500,000, more preferably 10,000-300,000, and even more preferably 30,000-200,000. When the weight average molecular weight is within this range, sufficient mechanical characteristics can be easily obtained. The molecular weight in the present specification is a value of polyethylene oxide (PEO) conversion by gel permeation chromatography (GPC). The molecular weight can be adjusted by a molar ratio of a diamine to an acid dianhydride or a reaction condition, or the like.

[Polyimide Solution]

A polyimide solution is prepared by dissolving the above polyimide resin in an appropriate solvent. The solvent is not particularly limited as long as the solvent can dissolve the above polyimide resin, and examples thereof include solvents such the urea-based solvents, sulfone-based solvents, amide-based solvents, alkyl halide-based solvents, aromatic hydrocarbon-based solvents, and ether-based solvents exemplified above as examples of an organic solvent used for polymerization of a polyamic acid. In addition to these solvents, ketone-based solvents such as acetone (boiling point: 56° C.), methyl ethyl ketone (boiling point: 80° C.), methyl propyl ketone (boiling point: 102° C.), methyl isopropyl ketone (boiling point: 94° C.), methyl isobutyl ketone (boiling point: 116° C.), diethyl ketone (boiling point: 102° C.), cyclopentanone (boiling point: 131° C.), cyclohexanone (boiling point: 156° C.) and methylcyclohexanone (boiling point: 168° C.) can also be suitably used as solvents for the polyimide resin composition.

Among these solvents, amide-based solvents, aromatic hydrocarbon-based solvents, or ketone-based solvents are preferable. Among them, from a point of view of having a low boiling point and allowing production efficiency of a polyimide film to be improved, the ketone-based solvents are preferable. Among the ketone-based solvents, those having a boiling point of 150° C. or lower are preferable, those having a boiling point of 120° C. or lower are more preferable, and those having a boiling point of 100° C. or lower are even more preferable. As described above, by setting the ratio of the alicyclic acid dianhydride and the BPDA in the acid dianhydride components within a predetermined range, a polyimide having a high solubility even with respect to a low boiling point solvent such as a ketone-based solvent can be obtained.

In the polyimide solution, with respect to a total solvent amount of 100 parts by weight, a ketone-based solvent is preferably 50 or more parts by weight, more preferably 70 or more parts by weight, and even more preferably 80 or more parts by weight. Further, the boiling point of the solvent of the polyimide solution is preferably 150° C. or lower, more preferably 120° C. or lower, and even more preferably 100° C. or lower.

The polyimide solution may contain a resin component other than a polyimide or additives. Examples of the additives include an ultraviolet absorbing agent, a cross-linking agent, a dye, a surfactant, a leveling agent, a plasticizer, fine particles, and the like. A content of the polyimide resin with respect to 100 parts by weight of a solid content of the polyimide resin composition is preferably 60 or more parts by weight, more preferably 70 or more parts by weight, and even more preferably 80 or more parts by weight.

A solid content concentration and viscosity of the polyimide solution may be appropriately set according to a molecular weight of the polyimide, a thickness of a film, a film forming environment, or the like. The solid content concentration is preferably 5-30 weight %, more preferably 8-25 weight %, and even more preferably 10-21 weight %. The viscosity at 25° C. is preferably 0.5 Pa·s-60 Pa·s, more preferably 2 Pa·s-50 Pa·s, and even more preferably 5 Pa·s-40 Pa·s.

[Polyimide Film]

<Production Method for Polyimide Film>

Methods for producing a polyimide film include a method in which a polyamic acid solution is applied in a form of a film onto a substrate and the solvent is removed by drying and the polyamic acid is imidized, and a method in which a polyimide resin solution is applied in a form of a film onto a substrate and the solvent is removed by drying. Since the polyimide resin of the present invention is soluble, any one of the methods can be adopted. From a point of view of obtaining a polyimide film having less residual impurities, a high transparency and an excellent mechanical strength, the latter method is preferable. In the latter method, the above polyimide solution is used.

A thickness of a polyimide film is not particularly limited and may be appropriately set according to an intended use. The thickness of the polyimide film is, for example, 5 μm or more. From a point of view of allowing a polyimide film after being peeled off from a support to have a self-supporting property, the thickness of the polyimide film is preferably 20 μm or more, more preferably 25 μm or more, and even more preferably 30 μm or more. In applications for which sufficient strength is required, such as a cover window material for a display, the thickness of the polyimide film may be 40 μm or more, or 50 μm or more. Although an upper limit for the thickness of the polyimide film is not particularly limited, from a point of view of flexibility and transparency, the upper limit is preferably 200 μm or less, more preferably 150 μm or less, and even more preferably 100 μm or less.

As a support onto which a film-forming dope is applied, a glass substrate, a metal substrate such as an SUS substrate, a metal drum, a metal belt, a plastic film, or the like can be used. From a point of view of improving productivity, it is preferable to produce a film by roll-to-roll using, as the support, an endless support such as a metal drum or a metal belt, or a long plastic film, or the like. When a plastic film is used as the support, a material that does not dissolve in the solvent for the film-forming dope may be appropriately selected. As the plastic material, polyethylene terephthalate, polycarbonate, polyacrylate, polyethylene naphthalate or the like can be used.

A polyimide film is obtained by applying the polyimide resin composition onto a support and removing the solvent by drying. Heating is preferably performed during drying of the solvent. A heating temperature is not particularly limited, and is appropriately set in a range of from a room temperature to about 250° C. The heating temperature may be increased stepwise.

<Characteristics of Polyimide Film>

A polyimide film used for a display or the like preferably has a low yellowness (YI). The yellowness of the polyimide film is preferably 3.0 or less, more preferably 2.5 or less, even more preferably 2.0 or less, and particularly preferably 1.5 or less. A light transmittance of the polyimide film at a wavelength of 400 m is preferably 70% or more, more preferably 75% or more, and even more preferably 80% or more. An absorbance (A₄₀₀) of the polyimide film per 100 μm in thickness at a wavelength of 400 nm is preferably 0.6 or less, more preferably 0.5 or less, and even more preferably 0.4 or less. A total light transmittance of the polyimide film is preferably 85% or more, more preferably 88% or more, and even more preferably 90% or more. A haze of the polyimide film is preferably 1.5% or less, more preferably 1% or less, even more preferably 0.9% or less, and particularly preferably 0.8% or less.

When ultraviolet absorptivity is required for the polyimide film, a light transmittance thereof at a wavelength of 380 nm is preferably 50% or less, more preferably 40% or less, even more preferably 30% or less, and particularly preferably 20% or less. An absorbance (A₃₈₀) of the polyimide film per 100 μm in thickness at a wavelength of 380 nm is preferably 1 or more, more preferably 1.5 or more, even more preferably 2 or more, and particularly preferably 2.5 or more. In order to impart ultraviolet absorptivity to the polyimide film, an ultraviolet absorbing agent may be used. The polyimide resin of the present invention contains the BPDA as an acid dianhydride component, and thus, is excellent in ultraviolet absorptivity. Therefore, even when the polyimide film does not contain an ultraviolet absorbing agent, the light transmittance at a wavelength of 380 nm can be reduced. Further, even when an ultraviolet absorbing agent is used, an additive amount of the ultraviolet absorbing agent can be reduced, and thus, problems such as a decrease in transparency due to compatibility or bleed out of the ultraviolet absorbing agent can be prevented.

A coefficient of hygroscopic expansion of the polyimide film is preferably 35 ppm/% RH or less, and more preferably 30 ppm/% RH or less. A tensile elastic modulus of the polyimide film is preferably 3 GPa or more, more preferably 3.5 GPa or more, and even more preferably 4 GPa or more. From a point of view of preventing the film from being damaged due to contact with a roll during roll-to-roll carrying or contact between films during winding, a pencil hardness of the polyimide film is preferably 2H or more. When the polyimide film is used for a cover window of a display or the like, the polyimide film is required to be scuff-resistant against an external contact. Therefore, the pencil hardness of the polyimide film is preferably 3H or more, and more preferably 4H or more. From a point of view of heat resistance, a glass transition temperature of the polyimide film is preferably 200° C. or higher, more preferably 250° C. or higher, and even more preferably 300° C. or higher.

<Applications of Polyimide Film>

The polyimide film of the present invention has a low yellowness, a high transparency, and a low hygroscopic expansion, and thus, can be suitably used as a material for a display. In particular, the polyimide film having a high mechanical strength can be applied to a surface member such as a cover window of a display. Further, since a dimensional change due to an environmental change is small, the polyimide film can also be suitably used as a material for various substrates. In practical use, an antistatic layer, an easy adhesion layer, a hard coat layer, an anti-reflection layer, and the like may be provided on a surface of the polyimide film of the present invention.

### Examples

In the following, the present invention is further described in detail based on examples and comparative examples. The present invention is not limited to the following examples.

[Synthesis of Polyamic Acid]

138 g of N,N-dimethylformamide (DMF) was charged into a 500 mL separable flask and was stirred under a nitrogen atmosphere. Diamines and acid dianhydrides were added thereto at ratios shown in Table 1, and the mixture was stirred under a nitrogen atmosphere for 5 hours to allow a reaction to proceed, and thereby, a polyamic acid solution having a solid content concentration of 18% was obtained. Abbreviations of the monomers shown in Table 1 are as follows. In Comparative Example 7, polymerization did not proceed and the subsequent studies were not performed.
TFMB: 2,2′-bis(trifluoromethyl) benzidine
3,3′-DDS: 3,3′-diaminodiphenyl sulfone
CBDA: 1,2,3,4-cyclobutanetetracarboxylic acid dianhydride
BPDA: 3,3′,4,4′-biphenyl-tetracarboxylic acid dianhydride
6FDA: 2,2-bis(3,4-dicarboxyphenyl) hexafluoropropane dianhydride
PMDA: pyromellitic acid dianhydride
CpODA: norbornane-2-spiro-α-cyclopentanone-α′-spiro-2″-norbornane-5,5″,6,6″-tetracarboxylic acid dianhydride
TATFMB: amide group-containing tetracarboxylic acid dianhydride represented by the following formula.

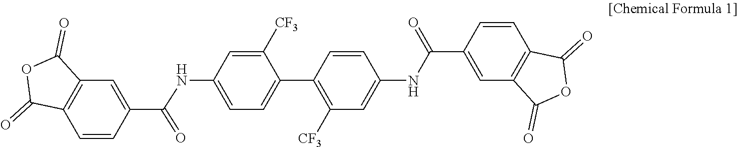 [SMILES: O=C(Nc1ccc(-c2ccc(NC(=O)c3ccc4c(c3)C(=O)OC4=O)cc2C(F)(F)F)c(C(F)(F)F)c1)c1ccc2c(c1)C(=O)OC2=O]

[Imidization and Precipitation of Polyimide Resin]

35.6 g of pyridine as an imidization catalyst was added to the polyamic acid solution, and, after the pyridine was complete dispersed, 45.9 g of acetic anhydride was added thereto. Thereafter, stirring was continued. For those for which gelation due to a rapid increase in viscosity occurred, the solubility during imidization was indicated as “NG,” and for those for which gelation did not occur, the solubility was indicated as “OK.” For Comparative Examples 2 and 3 for which the solubility during imidization was “NG,” subsequent studies were not performed.

For those for which the solubility was “OK,” imidization was performed by stirring for 2 hours at 120° C., and then, cooling to a room temperature was performed. While the obtained polyimide solution was stirred, 1 L of isopropyl alcohol (IPA) was added thereto at a rate of 2-3 drops/second to precipitate a polyimide. Thereafter, suction filtration was performed using a Kiriyama funnel and washing was performed using 500 g of IPA. The washing operation was repeated four times and then drying was performed in a vacuum oven set to 120° C. for 12 hours, and a polyimide resin was obtained.

[Evaluation of Solubility of Polyimide Resin]

The polyimide resin was added to DMF or methyl ethyl ketone (MEK) at a room temperature such that a resin concentration became 20 weight %, and the mixture was stirred, and solubility was confirmed. For each of DMF and MEK, for those for which a clear solution was obtained, the solubility was indicated as “OK,” and for those for which the solution was opaque or insoluble matter was found, the solubility was indicated as “NG.”

[Production of Polyimide Film]

For each of Examples 1 and 2 and Comparative Examples 1, 4, 5 and 6, the polyimide resin was dissolved in MEK, and a polyimide solution having a solid content concentration of 17% was obtained. The polyimide solution was applied onto an alkali-free glass plate using a comma coater, and was dried at 40° C. for 10 minutes, at 80° C. for 30 minutes, at 150° C. for 30 minutes and at 170° C. for 1 hour under an air atmosphere, and then, a resulting film was peeled off from the alkali-free glass plate and a polyimide film having a thickness of 30 μm was obtained. For Example 3, the resin was dissolved in DMF and a polyimide solution having a solid content concentration of 17% was prepared. The polyimide solution was applied onto an alkali-free glass plate using a comma coater, and was dried at 40° C. for 10 minutes, at 80° C. for 30 minutes, at 150° C. for 1 hour and at 200° C. for 1 hour under an air atmosphere, and then, a resulting film was peeled off from the alkali-free glass plate and a polyimide film having a thickness of 30 μm was obtained.

[Evaluation of Polyimide Film]

The mechanical strength (pencil hardness and tensile elastic modulus), the transparency (yellowness (YI), total light transmittance and haze) and the dimensional stability (coefficient of hygroscopic expansion (CHE)) of the polyimide film were measured according to the following.

(Pencil Hardness)

The pencil hardness of the film was measured according to “8.4.1 Pencil Scratch Test” of JIS K-5400-1990.

(Tensile Elastic Modulus)

Measurement was performed according to ASTM D882 using AUTOGRAPH AGS-J manufactured by Shimadzu Corporation. (Sample measurement range: width: 15 mm; distance between jaws: 100 mm; tensile speed: 200 mm/min; measurement temperature: 23° C.). Samples moisture-conditioned by being allowed to stand at 23° C. and 55% RH for one week were measured.

(Yellowness)

An average value of results measured at 5 places of an 18 cm square sample using HANDY COLORIMETER NR-3000 manufactured by Nippon Denshoku Industries Co., Ltd., was taken as the yellowness of the film.

(Total Light Transmittance and Haze)

Measurement was performed according to a method described in JIS K7105-1981 using an Integrating sphere type haze meter 300A manufactured by Nippon Denshoku Industries Co., Ltd.

(Coefficient of Hygroscopic Expansion)

The polyimide film was cut out into a test piece having a width of 5 mm and a length of 20 mm, and was held at 40% RH for 3 hours at a measuring jig interval of 15 mm, a load of 3 g and a temperature of 23° C. using a thermomechanical analyzer (TMA8310 manufactured by Rigaku) and a humidity and atmosphere adjustment device (HUM-1 manufactured by Rigaku), and thereafter, the humidity was changed to 70% RH at a rate of 20% RH/minute, and then, the polyimide film was held at 70% RH for 3 hours. The coefficient of hygroscopic expansion (CHE) of the polyimide film was determined from a ratio of a dimensional change rate of the test piece held at a humidity of 70% RH for 3 hours based on a length of the test piece held at a humidity of 40% RH for 3 hours to a humidity change amount (30% RH).

Table 1 shows the polyimide resin compositions, the solubilities, and the evaluation results of the films of the examples.

TABLE 1

| | Monomer Compositions | | | | | | | | Solubility | | |
|---|---|---|---|---|---|---|---|---|---|---|---|
| | Acid Dianhydrides | | | | | | Diamines | | | Polyimide | |
| | CBDA | BPDA | 6FDA | PMDA | TATFMB | CpODA | TFMB | 3,3′-DDS | Solution | Resin | |
| | mol % | mol % | mol % | mol % | mol % | mol % | mol % | mol % | Imidization | DMF | MEK |
| Example 1 | 50 | 10 | 40 | — | — | — | 70 | 30 | OK | OK | OK |
| Example 2 | 40 | 20 | 40 | — | — | — | 70 | 30 | OK | OK | OK |
| Example 3 | 30 | 30 | 40 | — | — | — | 70 | 30 | OK | OK | NG |
| Comparative | 60 | — | 40 | — | — | — | 70 | 30 | OK | OK | OK |
| Example 1 | | | | | | | | | | | |
| Comparative | 80 | 20 | — | — | — | — | 70 | 30 | NG | | |
| Example 2 | | | | | | | | | | | |
| Comparative | 80 | 20 | — | — | — | — | 100 | 0 | NG | | |
| Example 3 | | | | | | | | | | | |
| Comparative | — | — | 100 | — | — | — | 50 | 50 | OK | OK | OK |
| Example 4 | | | | | | | | | | | |
| Comparative | 50 | — | 40 | 10 | — | — | 70 | 30 | OK | OK | OK |
| Example 5 | | | | | | | | | | | |
| Comparative | 50 | — | 30 | — | 20 | — | 70 | 30 | OK | OK | OK |
| Example 6 | | | | | | | | | | | |

| | | | | | | | | |
|---|---|---|---|---|---|---|---|---|
| Comparative | 50 | — | 30 | — | — | 20 | 70 | 30 |
| Example 7 | | | | | | | | |

| | Film Characteristics | | | | | | | |
|---|---|---|---|---|---|---|---|---|
| | Pencil | Elastic | Yellowness | Transmittance | | Total Light | | CHE |
| | Hardness | Modulus | (Yl) | 380 nm | 400 nm | Transmittance | Haze | ppm/ |
| | — | GPa | — | % | % | % | % | % RH |
| Example 1 | 4H | 4.3 | 1.2 | 34 | 81 | 90 | 0.5 | 33.0 |
| Example 2 | 4H | 4.1 | 1.4 | 18 | 76 | 90 | 0.7 | 29.5 |
| Example 3 | 4H | 4.1 | 1.6 | 6 | 68 | 90 | 0.6 | 25.3 |
| Comparative | 4H | 4.0 | 1.2 | 73 | 86 | 90 | 0.8 | 37.0 |
| Example 1 | | | | | | | | |
| Comparative | | | | | | | | |
| Example 2 | | | | | | | | |
| Comparative | | | | | | | | |
| Example 3 | | | | | | | | |
| Comparative | 2H | 3.4 | 1.4 | 61 | 84 | 90 | 0.9 | N.D |
| Example 4 | | | | | | | | |
| Comparative | 4H | 4.0 | 2.6 | 21 | 62 | 89 | 0.5 | N.D |
| Example 5 | | | | | | | | |
| Comparative | 2H | 4.1 | 3.0 | N.D | N.D | 89 | 1.2 | N.D |
| Example 6 | | | | | | | | |

Comparative
Example 7

In Comparative Example 1 in which CBDA (which is an alicyclic acid dianhydride) and 6FDA (which is a fluorine-containing aromatic acid dianhydride) were used as acid dianhydrides and TFMB (which is a fluoroalkyl-substituted benzidine) and 3,3′DDS were used as diamines, gelation during imidization did not occur, the solubility of the polyimide resin in the solvent was good, and the film was excellent in mechanical strength and in transparency. However, the coefficient of hygroscopic expansion of the polyimide film of Comparative Example 1 exceeded 35 ppm/% RH.

In Examples 1-3 in which the amount of CBDA of Comparative Example 1 was reduced and BPDA was added instead, as the ratio of BPDA was increased, the coefficient of hygroscopic expansion was decreased, indicating a high dimensional stability. Further, in all Examples 1-3, gelation during imidization in the solution did not occur, a solvent solubility equivalent to that of Comparative Example 1 was exhibited, and the polyimide film exhibited a mechanical strength equivalent to that of Comparative Example 1.

In Comparative Example 1 and Examples 1-3, the transmittance at a wavelength of 400 nm gradually decreased along with the increase in the amount of BPDA used, while the transmittance at a wavelength of 380 nm sharply decreased along with the increase in the amount of BPDA used.

In Comparative Examples 2 and 3 in which CBDA and BPDA were used as acid dianhydrides and 6FDA was not used, gelation occurred during imidation from a polyamic acid solution, and a polyimide resin could not be isolated. From the results of Comparative Examples 2 and 3, it can be seen that the solvent solubility of the polyimide is improved by using the alicyclic acid dianhydride and the fluorine-containing aromatic acid dianhydride as acid dianhydride components.

In Comparative Example 7 in which CpODA (which is an alicyclic acid dianhydride) was used as an acid dianhydride in addition to CBDA and 6FDA, reactivity was low and a polyamic acid was not obtained. In Comparative Example 5 in which PMDA (which is an aromatic acid dianhydride) was used as an acid dianhydride in addition to CBDA and 6FDA, the yellowness of the polyimide film was increased. In Comparative Example 6 in which TATFMB (which is a fluorine-containing aromatic acid dianhydride) was used in addition to CBDA and 6FDA, the yellowness was increased and the pencil hardness was decreased. In Comparative Example 4 in which only 6FDA was used as an acid dianhydride, the pencil hardness and the elastic modulus were decreased.

From these results, it can be seen that, when BPDA is used as an acid dianhydride component in addition to the alicyclic acid dianhydride and the fluorine-containing aromatic acid dianhydride, while the solubility, the transparency and the mechanical strength are maintained, the dimensional stability can be improved by reducing the hygroscopic expansion. Further, by using BPDA as an acid dianhydride component, it is possible to impart absorbance with respect to ultraviolet light of wavelengths near 380 nm.

In Example 3 in which CBDA and BPDA were used at a ratio of 1:1, the polyimide resin exhibited solubility with respect to DMF, but did not dissolve in MEK which is a ketone-based solvent. On the other hand, in Examples 1 and 2, similar to Comparative Example 1, the polyimide resin dissolved in both DMF and MEK. From these results, it can be seen that, by using the alicyclic acid dianhydride and the BPDA at ratios within a predetermined range (for example, BPDA is 40 mol % or less with respect to a total amount of the alicyclic acid dianhydride and the BPDA), a polyimide solution using a ketone-based solvent can be prepared, solvent removal efficiency when a film is formed using the polyimide solution can be increased, and productivity of the polyimide film can be improved.

1. A polyimide resin, comprising:
structures derived from acid dianhydrides; and
structures derived from diamines,
wherein the acid dianhydrides include an alicyclic acid dianhydride, a fluorine-containing aromatic acid dianhydride, and 3,3′,4,4′-biphenyl-tetracarboxylic acid dianhydride, and
the diamines include a fluoroalkyl-substituted benzidine and 3,3′-diaminodiphenyl sulfone.

2. The polyimide resin according to claim 1, wherein
with respect to a total amount of the acid dianhydrides, the alicyclic acid dianhydride and the 3,3′,4,4′-biphenyl-tetracarboxylic acid dianhydride are included at a total content of 40-95 mol %, and the fluorine-containing aromatic acid dianhydride is included at a content of 5-60 mol %, and
the 3,3′,4,4′-biphenyl-tetracarboxylic acid dianhydride is included at a content of 10-40 mol % with respect to a total amount of the alicyclic acid dianhydride and the 3,3′,4,4′-biphenyl-tetracarboxylic acid dianhydride.

3. The polyimide resin according to claim 1, wherein the acid dianhydrides include 5-40 mol % of the 3,3′,4,4′-biphenyl-tetracarboxylic acid dianhydride with respect to a total amount of the acid dianhydrides.

4. The polyimide resin according to claim 1, wherein, with respect to a total amount of the diamines, the diamines include 10-90 mol % of the fluoroalkyl-substituted benzidine and 10-90 mol % of the 3,3′-diaminodiphenyl sulfone.

5. The polyimide resin according to claim 1, wherein the alicyclic acid dianhydride is at least one selected from the group consisting of 1,2,3,4-cyclobutanetetracarboxylic acid dianhydride, 1,2,3,4-cyclopentanetetracarboxylic acid dianhydride, and 1,2,4,5-cyclohexanetetracarboxylic acid dianhydride.

6. The polyimide resin according to claim 1, wherein the fluorine-containing aromatic acid dianhydride is 2,2-bis(3,4-dicarboxyphenyl)-1,1,1,3,3,3-hexafluoropropane dianhydride.

7. The polyimide resin according to claim 1, wherein the fluoroalkyl-substituted benzidine is 2,2′-bis(trifluoromethyl) benzidine.

8. A method for producing the polyimide resin according to claim 1, comprising:
causing the diamines and the acid dianhydrides to react with each other in a solvent such that a polyamic acid solution is prepared;
mixing a dehydrating agent and an imidization catalyst with the polyamic acid solution such that the polyamic acid is imidized and that a polyimide solution is obtained; and
mixing the polyimide solution with a poor solvent for a polyimide such that the polyimide resin is precipitated.

9. A polyimide solution, produced by a process including dissolving the polyimide resin of claim 1 in an organic solvent.

10. The polyimide solution according to claim 9, wherein the organic solvent is a ketone-based solvent.

11. A polyimide film, comprising:
the polyimide resin of claim 1.

12. The polyimide film according to claim 11, having a pencil hardness of 4H or higher.

13. The polyimide film according to claim 11, having a thickness of 20 μm or more.

14. A method for producing a polyimide film comprising:
applying the polyimide solution according to claim 9 onto a substrate; and
removing the solvent.

15. The polyimide resin according to claim 1, wherein the alicyclic acid dianhydride is 1,2,3,4-cyclobutanetetracarboxylic acid dianhydride, the fluorine-containing aromatic acid dianhydride is 2,2-bis(3,4-dicarboxyphenyl)-1,1,1,3,3,3-hexafluoropropane dianhydride, and the fluoroalkyl-substituted benzidine is 2,2′-bis (trifluoromethyl) benzidine.

16. The polyimide resin according to claim 15, wherein
with respect to a total amount of the acid dianhydrides, the 1,2,3,4-cyclobutanetetracarboxylic acid dianhydride and the 3,3′,4,4′-biphenyl-tetracarboxylic acid dianhydride are included at a total content of 40-95 mol %, and the 2,2-bis(3,4-dicarboxyphenyl)-1,1,1,3,3,3-hexafluoropropane dianhydride is included at a content of 5-60 mol %, and
the 3,3′,4,4′-biphenyl-tetracarboxylic acid dianhydride is included at a content of 10-40 mol % with respect to a total amount of the 1,2,3,4-cyclobutanetetracarboxylic acid dianhydride and the 3,3′,4,4′-biphenyl-tetracarboxylic acid dianhydride.

17. The polyimide resin according to claim 15, wherein the acid dianhydrides include 5-40 mol % of the 3,3′,4,4′-biphenyl-tetracarboxylic acid dianhydride with respect to a total amount of the acid dianhydrides.

18. The polyimide resin according to claim 15, wherein, with respect to a total amount of the diamines, the diamines include 10-90 mol % of 2,2′-bis (trifluoromethyl) benzidine and 10-90 mol % of the 3,3′-diaminodiphenyl sulfone.

19. The polyimide resin according to claim 16, wherein, with respect to a total amount of the diamines, the diamines include 10-90 mol % of 2,2′-bis (trifluoromethyl) benzidine and 10-90 mol % of the 3,3′-diaminodiphenyl sulfone.

20. The polyimide resin according to claim 17, wherein, with respect to a total amount of the diamines, the diamines include 10-90 mol % of 2,2′-bis (trifluoromethyl) benzidine and 10-90 mol % of the 3,3′-diaminodiphenyl sulfone.
